(19) United States
(12) Patent Application Publication
(10) Pub. No.: US 2026/0250499 A1
(43) Pub. Date: Aug. 27, 2026

(54) ACRYLONITRILE STYRENE ACRYLATE (ASA) COPOLYMER COMPOSITION HAVING GOOD UV RESISTANCE WITH REDUCED UV ABSORBER CONTENT

(71) Applicant: INEOS STYROLUTION GROUP GMBH, Frankfurt am Main (DE)

(72) Inventors: Norbert NIESSNER, Friedelsheim (DE); Christian RUTHARD, Mainz (DE); Nils BECKER, Roesrath (DE); Samet GUELAK, Ortahisar/Trabzon (TR); Felix KLAUCK, Madrid (ES); Maren WISSING, Muenster (DE)

(21) Appl. No.: 18/928,839

(22) PCT Filed: Apr. 26, 2023
(86) PCT No.: PCT/EP2023/060957

§ 371 Date: Oct. 28, 2024

(30) Foreign Application Priority Data
Apr. 29, 2022 (EP) 22170996.7

(51) Int. Cl. C08L 25/12; C08K 3/04; C08K 3/22; C08K 5/00; C08K 5/3435; C08K 5/3475

(52) U.S. Cl. CPC C08L 25/12; C08K 3/04; C08K 5/0041; C08K 5/3435; C08K 5/3475; C08K 2003/2241; C08L 2201/08; C08L 2205/025; C08L 2205/035

(57) ABSTRACT

A thermoplastic molding composition P comprising: AB: at least one graft copolymer composition AB, consisting of at least one thermoplastic copolymer A and at least one graft copolymer B; C: at least one UV absorber as component C; and D: optionally at least one further additive as component D, wherein the UV absorber component C comprises at least one organic or inorganic component having an UV absorption at least in a wavelength range ≤380 nm; and wherein the UV absorber component C is at least partially selected from at least one black pigment, at least one white pigment and/or at least one dye having an UV absorption at least in a wavelength range ≤380 nm.

Impact modified molding compositions, such as acrylonitrile styrene acrylate (ASA), and blends thereof with other thermoplastic polymers are widely used in many applications, e.g. in automotive industry, electronic industry or for household goods. The popularity of these thermoplastic polymer compositions is attributed to their balanced properties of good impact strength, melt flow characteristics and high weathering stability.

In order to improve weathering stability of ASA formulations for use in exterior applications, UV stabilizers such as hindered amine light stabilizer (HALS) compounds or UV absorbers are often used. Several documents, such as U.S. Pat. Nos. 4,692,486, 9,701,813, EP-B 2593510 and DE-A 10316198 teach the use of HALS stabilizers and combinations thereof as UV absorbers and light stabilizers. Combinations of UV absorbers, HALS stabilizers and antioxidants are e.g. disclosed in US 2003/0074833, U.S. Pat. Nos. 7,084,197, 6,800,676, WO 2007/113248 and DE 103 08 506 A.

However, from the viewpoint of economic and ecological sustainability it is always desirable to reduce the total amount of additives in polymer compositions. This is particularly true for potentially harmful additives. In view of these needs, the present inventors carried out experiments to reduce the total amount UV stabilizers while substantially maintaining the UV stability of ASA copolymer compositions.

It was surprisingly found that conventional UV absorbers (such as benzotriazole type UV absorbers) may be partially or completely replaced by colorants with a UV absorption in a range of ≤380 nm without deterioration of the UV stability of the thermoplastic molding compositions.

The invention relates to a thermoplastic molding composition P, comprising (or consisting of):
AB: 86 to 99.9% by weight, preferably 92.5 to 99.86% by weight, more preferably 95.5 to 99.83%, often 97 to 99.75% by weight, based on the molding composition P, of at least one graft copolymer composition as component AB, consisting of:
   A: from 30 to 80% by weight, based on the weight of component AB, of at least one thermoplastic copolymer as component A, produced from:
      A1: from 50 to 95% by weight, based on the copolymer A, of a monomer A1 selected from styrene, α-methylstyrene and mixtures of styrene with at least one other monomer selected from α-methylstyrene, p methylstyrene and C₁-C₈-alkyl (meth)acrylate;
      A2: from 5 to 50% by weight, based on the copolymer A, of a monomer A2 selected from acrylonitrile and mixtures of acrylonitrile with at least one other monomer selected from methacrylonitrile, acrylamide, vinyl methyl ether, anhydrides of unsaturated carboxylic acids and imides of unsaturated carboxylic acids;
   B: from 20 to 70% by weight, based on the weight of component AB, of at least one graft copolymer as component B comprising:
      B1: from 50 to 90% by weight, based on the graft copolymer B, of at least one graft base B1 which is obtained via emulsion polymerization of:
         B11: from 70 to 99.9% by weight, based on the graft base B1, of at least one C₁-C₈-alkyl (meth)acrylate, as monomer B11;
         B12: from 0.1 to 10% by weight, based on the graft base B1, of at least one polyfunctional crosslinking monomer B12;
         B13: from 0 to 29.5% by weight, based on the graft base B1, of at least one other copolymerizable monomer B13, preferably selected from styrene, α-methylstyrene, C₁-C₄-alkylstyrene, acrylonitrile, methacrylonitrile, methyl methacrylate, C₉-C₂₀-alkyl methacrylates, and vinyl methyl ether;
      wherein the entirety of B11+B12+B13 provides 100% by weight of the at least one graft base B1; and
      B2: from 10 to 50% by weight, based on the graft copolymer B, of at least one graft shell B2 which is obtained via emulsion polymerization, in the presence of the at least one graft base B1, of:
         B21: from 50 to 100% by weight, based on the graft shell B2, of a monomer B21, selected from styrene, α-methylstyrene and mixtures of styrene with at least one other monomer selected from α-methylstyrene, p-methylstyrene and C₁-C₄-alkyl (meth)acrylate;
         B22: from 0 to 50% by weight, based on the graft shell B2, of a monomer B22 selected from acrylonitrile and mixtures of acrylonitrile with at least one other monomer selected from methacrylonitrile, acrylamide, vinyl methyl ether, anhydrides of unsaturated carboxylic acids and imides of unsaturated carboxylic acids;
         B23: from 0 to 20% of at least one further copolymerizable monomer B23;
         wherein the entirety of B21+B22+B23 provides 100% by weight of the at least one graft shell B2;
      wherein the entirety of graft base B1 and graft shell B2 provides 100% by weight of the at least one graft copolymer B;
C: 0.1 to 4% by weight, preferably 0.13 to 3% by weight, more preferably 0.16 to 2.5%, often 0.2 to 2% by weight, based on the molding composition P, of at least one UV absorber as component C; and
D: 0 to 10% by weight, preferably 0.01 to 4.5% by weight, more preferably 0.01 to 2%, often 0.05 to 1% by weight, based on the molding composition P, of at least one further additive as component D;
wherein the components A to D amount to 100% by weight of the molding composition P, wherein the UV absorber component C comprises at least one organic or inorganic component having an UV absorption at least in a wavelength range≤380 nm; and wherein the UV absorber component C is at least partially selected from at least one black pigment, at least one white pigment and/or at least one dye having an UV absorption at least in a wavelength range≤380 nm.

Within the meaning of the invention, a dye is an organic or inorganic component, which absorbs electromagnetic radiation at least in the wavelength range of visible light, i.e. in the wavelength range between 380 nm and 780 nm. In addition, suitable dyes according to the invention absorb electromagnetic radiation at least in the wavelength range of UV radiation, i.e. in the wavelength range below 380 nm, preferably in the range of from 100 nm to 380 nm, more preferably 200 nm to 380 nm, and in particular 250 nm to 380 nm.

In one embodiment of the invention, the UV absorber component C preferably comprises or consists of at least one organic or inorganic component selected from at least one black pigment, white pigment and/or at least one dye having an UV absorption at least in a wavelength range≤380 nm. More preferably, the UV absorber component C comprises or consists of at least one dye having an UV absorption at least in a wavelength range≤380 nm, preferably in the range of from 100 nm to 380 nm, more preferably 200 nm to 380 nm, and in particular 250 nm to 380 nm at least one white pigment and/or at least one black pigment.

In a further preferred embodiment, the UV absorber component C comprises or consists of at least one dye having an UV absorption at least in a wavelength range≤380 nm, selected from red, orange and yellow dyes, in particular yellow dyes. In addition, the UV absorber component C may comprise of at least one organic component having an UV absorption at least in a wavelength range≤380 nm, preferably 100 nm to 380 nm, more preferably 200 nm to 380 nm, and in particular 250 nm to 380 nm, which is not a pigment or a dye, i.e. exhibits no substantial absorption of electromagnetic radiation in the range of visible light between 380 nm and 780 nm. Known UV absorbers include compounds comprising one or more benzotriazole moieties.

The graft copolymer B preferably has a weight-average particle diameter dw of at least 50 nm, preferably of at least 80 nm, more preferably of at least 90 nm. This can e.g. be measured e.g. via ultra-centrifuge (Scholtan).

In a preferred embodiment of the invention, the amount of the at least one graft copolymer composition AB is ≥98% by weight, based on the thermoplastic molding composition P.

In a preferred embodiment, the at least one graft copolymer composition AB consists of:
A: 30 to 80% by weight, based on the graft copolymer composition AB, of at least one thermoplastic copolymer selected from poly(styrene-acrylonitrile) (SAN), poly(α-methyl styrene/acrylonitrile) (AMSAN), and mixtures thereof as component A; and
B: 20 to 70% by weight, based on the graft copolymer composition AB, of at least one graft copolymer B, comprising:
   B1:50 to 90% by weight, preferably 55 to 90% by weight, more preferably 55 to 65% by weight, based on the graft copolymer B, at least one graft base B1, obtained by emulsion polymerization.
      B11:70 to 99.9% by weight, preferably 87 to 99.5% by weight, based on the graft base B1, n-butylacrylate, as monomer B11;
      B12:0.1 to 10% by weight, preferably 0.1 to 5% by weight, more preferably 1 to 2.5% by weight, based on the graft base B1 of at least on poly-functional cross-linking monomer B12;
      B13: from 0 to 29.5% by weight, preferably from 0 to 20% by weight, more preferably from 0 to 10% by weight, based on the graft base B1, of at least one other copolymerizable, monoethylenic unsaturated monomer B13, preferably selected from styrene, α-methylstyrene, C₁-C₄-alkylstyrene, acrylonitrile, methacrylonitrile, methyl methacrylate, C₉-C₂₀-alkyl methacrylates, and vinyl methyl ether;
   wherein the sum of B11, B12 and B13 equals 100% by weight of B1; and
   B2:10 to 50% by weight, preferably 10 to 45% by weight, more preferably 35 to 45% by weight, based on the graft copolymer B, at least one graft shell B2, which is obtained via emulsion polymerization in the presence of at least one graft base B1:
      B21 50 to 95% by weight, more preferably 65 to 80% by weight, most preferred 75 to 80% by weight, based on the graft shell B2 of a monomer B21, of styrene; and
      B22 5 to 50% by weight, more preferably 20 to 35% by weight, most preferred 20 to 25% by weight, based on the graft shell B2 of at least one monomer B22 chosen from acrylonitrile or mixtures of acrylonitrile and at least one further monomer chosen from methacrylonitrile;
      B23: from 0 to 20% of at least one further copolymerizable monomer B23;
   wherein the sum of B21, B22 and B23 equals 100% by weight of the at least one graft shell B2;
   wherein the total sum of graft base B1 and graft shell B2 equals 100% by weight of the graft copolymer B, and
wherein the at least one graft copolymer B has a weight-average particle diameter dw of 50 to 1000 nm, preferably 50 to 900 nm, in particular 80 to 700 nm.

A further object of the invention is the use of a thermoplastic molding composition P as described herein for producing molded articles.

In a further aspect, the invention also relates to molded articles comprising the thermoplastic molding composition P as described herein.

According to the invention, the thermoplastic molding composition P comprises or consists of:
AB: at least one graft copolymer composition AB, consisting of at least one thermoplastic copolymer A and at least one graft copolymer B;
C: at least one UV absorber as component C, wherein the UV absorber component C is at least partially selected from at least one black pigment, at least one white pigment and/or at least one dye having an UV absorption at least in a wavelength range≤380 nm; and
D: optionally at least one further additive as component D.

According one embodiment of the invention, the thermoplastic molding composition P comprises or consists of:
AB: at least one graft copolymer composition AB, consisting of at least one thermoplastic copolymer A and at least one graft copolymer B;
C: at least one UV absorber as component C, wherein the UV absorber component C is at least partially selected from at least one black pigment, at least one white pigment and/or at least one dye having an UV absorption at least in a wavelength range≤380 nm; and
D: at least one further additive as component D, wherein component D comprises at least one hindered amine light stabilizers (HALS).

The constituents A to D of the thermoplastic molding composition P are described in further detail in the following.

### Graft Copolymer Composition AB

The thermoplastic molding composition P according to the invention comprises 86 to 99.9% by weight, based on the molding composition P, at least one graft copolymer composition as component AB.

The at least one graft copolymer composition AB comprises or consists of at least one thermoplastic copolymer as component A and at least one graft copolymer as component B having the following compositions:
A: from 30 to 80% by weight, preferably 40 to 75% by weight, more preferably 50 to 65% by weight, most preferably 55 to 65% by weight, based on the graft copolymer composition AB, of at least one thermoplastic copolymer as component A, produced from:
   A1: from 50 to 95% by weight, preferably 55 to 80% by weight, more preferably 60 to 75% by weight, often 62 to 68% by weight, based on the copolymer A, of a monomer A1 selected from styrene, α-methylstyrene and mixtures of styrene with at least one other monomer selected from α-methylstyrene, p-methylstyrene and C₁-C₈-alkyl (meth)acrylate;
   A2: from 5 to 50% by weight, preferably 20 to 45% by weight, more preferably 25 to 40% by weight, often 32 to 38% by weight, based on the copolymer A, of a monomer A2 selected from acrylonitrile and mixtures of acrylonitrile with at least one other monomer selected from methacrylonitrile, acrylamide, vinyl methyl ether, anhydrides of unsaturated carboxylic acids and imides of unsaturated carboxylic acids;
B: from 20 to 70% by weight, preferably 25 to 60% by weight, more preferably 35 to 50% by weight, often 35 to 45% by weight, based on the graft copolymer compositions AB, of at least one graft copolymer B comprising:
   B1: from 50 to 90% by weight, preferably 52 to 80% by weight, more preferably 54 to 70% by weight, often 55 to 65%, by weight based on the graft copolymer B, of at least one graft base B1 which is obtained via emulsion polymerization of:
      B11: from 70 to 99.9% by weight, preferably 87 to 99.5% by weight, more preferably 87.5 to 99% by weight, based on the graft base B1, of at least one C₁-C₆-alkyl (meth)acrylate, as monomer B11;
      B12: from 0.1 to 10% by weight, preferably 0.1 to 5% by weight, more preferably 1 to 2.5% by weight, based on the graft base B1, of at least one polyfunctional crosslinking monomer B12;
      B13: from 0 to 29.5% by weight, preferably from 0 to 20% by weight, more preferably from 0 to 10% by weight, based on the graft base B1, of at least one other copolymerizable, monoethylenic unsaturated monomer B13, preferably selected from styrene, α-methylstyrene, C₁-C₄-alkylstyrene, acrylonitrile, methacrylonitrile, methyl methacrylate, C₉-C₂₀-alkyl methacrylates, and vinyl methyl ether;
   wherein the entirety of B11+B12+B13 provides 100% by weight of the at least one graft base B1; and
   B2: from 10 to 50% by weight, preferably 20 to 48% by weight, more preferably 30 to 46% by weight, often 35 to 45% by weight, based on the graft copolymer B, of at least one graft shell B2 which is obtained via emulsion polymerization, in the presence of the at least one graft base B1, of:
      B21: from 50 to 100% by weight, preferably 60 to 90% by weight, more preferably 70 to 80% by weight, often 73 to 77% by weight, based on the graft shell B2, of a monomer B21, selected from styrene, α-methylstyrene and mixtures of styrene with at least one other monomer selected from α-methylstyrene, p-methylstyrene and C₁-C₄-alkyl (meth)acrylate;
      B22: from 0 to 50% by weight, preferably 10 to 40% by weight, more preferably 20 to 30% by weight, often 23 to 27% by weight, based on the graft shell B2, of a monomer B22 selected from acrylonitrile and mixtures of acrylonitrile with at least one other monomer selected from methacrylonitrile, acrylamide, vinyl methyl ether, anhydrides of unsaturated carboxylic acids and imides of unsaturated carboxylic acids;
      B23: from 0 to 20% of at least one further copolymerizable monomer B23;
   wherein the entirety of B21+B22+B23 provides 100% by weight of the at least one graft shell B2;
   wherein the entirety of graft base B1 and graft shell B2 provides 100% by weight of the at least one graft copolymer B.

Thermoplastic copolymer A

The thermoplastic copolymer A is preferable a rubber-free resin.

In a preferred embodiment of the invention monomer A1 is styrene or alpha-methylstyrene, monomer A2 is acrylonitrile. In an alternative embodiment of the invention, monomer A1 is a mixture of styrene and alpha-methylstyrene and monomer A2 is acrylonitrile. The described mixture preferably comprises at least 10% by weight, preferably at least 50% by weight and most preferably at least 90% by weight styrene, based on the total amount of monomer A1.

Especially preferred are thermoplastic copolymers A produced from (consisting of):
50 to 95% by weight, preferably 55 to 80% by weight, more preferably 60 to 75% by weight, often 62 to 68% by weight, related to the total copolymer A, of monomer A1 selected from styrene, alpha-methylstyrene or mixtures of styrene and alpha-methylstyrene, and
5 to 50% by weight, preferably 20 to 45% by weight, more preferably 25 to 40% by weight, often 32 to 38% by weight, related to the total copolymer A, of monomer A2 selected from acrylonitrile or mixtures of acrylonitrile and methacrylonitrile.

Most preferred is a thermoplastic copolymer A comprising 35% by weight acrylonitrile, or less, acrylonitrile, related to the total copolymer A.

The weight average molecular weight Mw of copolymer A (as determined by gel permeation chromatography relative to polystyrene as standard) is often in the range of 15,000 to 200,000 g/mol, preferably in the range of 30,000 to 150.000 g/mol. The viscosity number VN of copolymer A is preferably from 50 to 100 cm³/g, more preferably from 55 to 85 g/cm³ (determined according to DIN 53726 at 25° C., 0.5% by weight in dimethylformamide).

Poly(styrene-acrylonitrile) (SAN) and poly(α-methyl styrene/acrylonitrile) (AMSAN) are known and the methods for their preparation, for instance, by radical polymerization, more particularly by emulsion, suspension, solution and bulk polymerization are also well documented in the literature.

The synthesis of thermoplastic copolymer A is for example described in DE-A 24 20 358 and DE-A 27 24 360. Suitable thermoplastic copolymers are also described in DE-A 1 971 3509. Synthesis of thermoplastic copolymers A is possible via thermal initiation or via addition of initiators, especially radical initiators, like for example peroxides. Suitable thermoplastic copolymers A are preferably produced via mass or solution polymerization. The copolymers may be added alone or as an arbitrary mixture.

### Graft Copolymer B

According to the invention the graft copolymer composition AB comprises at least one graft copolymer B, especially ASA-graft rubber, comprising 50 to 90% by weight, preferably 55 to 90% by weight, based on the graft copolymer B, of at least one graft base B1 and 10 to 50% by weight, preferably 10 to 45% by weight, based on the graft copolymer B, of at least one graft shell B2, preferably one to three graft shells B2, wherein the total sum of graft base B1 and graft shell(s) B2 equals 100% by weight.

In a preferred embodiment of the invention graft copolymer B comprises 10 to 50% by weight, preferably 10 to 45% by weight, most preferably 35 to 45% by weight, based on the total graft copolymer B, of at least one graft shell B2, which is obtained from emulsion polymerization of:
B21:50 to 95% by weight, preferably 65 to 80% by weight, often 75 to 80% by weight, based on the graft shell B2, of at least one monomer B21, chosen from styrene, alpha-methylstyrene or mixtures of styrene and one further monomer chosen from alpha-methylstyrene, p-methylstyrene, C₁-C₄-alkyl (meth)acrylate (e.g. methylmethacrylate, ethylmethacrylate), preferably chosen from styrene, alpha-methylstyrene or mixtures of styrene and alpha-methylstyrene or methylmethacrylate and
B22:5 to 50% by weight, preferably 20 to 35% by weight, often 20 to 25% by weight, based on the graft shell B2, of at least one monomer B22, chosen from acrylonitrile or mixtures of acrylonitrile and at least one further monomer chosen from methacrylonitrile, acrylamide, vinylmethylether, anhydrides of unsaturated carboxylic acids (e.g. maleic acid anhydride, phthalic acid anhydride) and imides of unsaturated carboxylic acids (e.g. N-substituted maleimide, like N-cyclohexylmaleimide and N-phenylmaleimide), preferred chosen from acrylonitrile or mixtures of acrylonitrile and methacrylonitrile;
wherein the total sum of B21 and B22 equals 100% by weight.

Preferably graft copolymer B comprises a graft base B1, described above, of a cross-linked polybutylacrylate rubber and exactly one graft shell B2, obtained by emulsion polymerization of monomers B21 and B21, like described above, especially styrene or acrylonitrile, in presence of graft base B1 (single graft shell B2). Further preferred is a graft copolymer B comprising a graft base B1 (described above), comprising cross-linked polybutylacrylate rubber and two graft shells B2′ and B2″, wherein B2′ is obtained from emulsion polymerization of monomer B21, especially styrene, in presence of graft base B1. The graft shell B2″ is obtained from subsequent emulsion polymerization of monomers B21 and B22 (as described), especially styrene and acrylonitrile, in presence of graft base B1, already grafted with B2′ (two-stage graft).

Especially preferred, the graft base B1 is obtained by emulsion polymerization of:
B11: preferred 87 to 99.5% by weight, based on the graft base B1, of at least one C4-C8-alkyl (meth)acrylate, more preferred n-butylacrylate and/or 2-ethylhexylacrylate, most preferred solely n-butylacrylate;
B12:0.5 to 5% by weight, preferably, 0.5 to 3% by weight, most preferred 1 to 2.5% by weight, based on the graft base B1, of at least one polyfunctional, crosslinking monomers B12, preferably chosen from isoprene, butadiene, chloroprene, alkylene glycol di(meth)acrylate, allyl(meth)acrylate, divinylbenzene, diallylmaleate, diallylfumarate, diallylphthalate, triallylcyanurate, triallylisocyanurate and dihydrodicyclopentadienyl acrylate (DCPA), especially preferred allyl(meth)acrylate and/or dihydrodicyclopentadienyl acrylate (DCPA);
B13:0 to 29.9% by weight, preferably 0 to 10% by weight, most preferred 0.5 to 10% by weight, based on the graft base B1, of at least one further copolymerizable, monoethylenic unsaturated monomer B13, preferably selected from styrene, α-methylstyrene, C₁-C₄-alkylstyrene, acrylonitrile, methacrylonitrile, methyl methacrylate, C₉-C₂₀-alkyl methacrylates, and vinyl methyl ether;
wherein the sum of B11, B12, B13 equals 100% by weight.

Preferred monomers B11 for producing graft base B1 are alkylacrylate and/or alkylmethacrylate with 1 to 8, preferred 4 to 8, carbon atoms being present in the alkyl group. Especially preferred is n-butylacrylate and/or 2-ethylhexylacrylate, most preferred is n-butylacrylate, as monomer B11. Preferred said alkylacrylates are used alone as monomers B11.

In order to have cross-linking of the C₁-C₈-alkyl (meth)acrylate monomers B11 and therefore cross-linking of the graft base B1, monomers B11 are polymerized in presence of 0.1 to 10% by weight, preferably 0.1 to 5% by weight, preferably 0.5 to 3% by weight, preferably 1 to 4% by weight, more preferably 1 to 2.5% by weight, based on the graft base B1, of one polyfunctional, cross-linking monomer B12. Suitable monomers B12 are especially polyfunctional, cross-linking monomers, that can be copolymerized with the mentioned monomers, especially B11 and B13. Suitable polyfunctional, cross-linking monomers B12 comprise two or more, preferred two or three, more preferred exactly two ethylenic double bonds, which are preferably not 1,3 conjugated. Examples for suitable polyfunctional, cross-linking monomers B12 are allyl(meth)acrylate, divinylbenzene, diallylester of carboxylic diacids, like e.g. diallylmaleate, diallylfumarate and diallylphthalate.

The acrylic acid ester of tricyclodecenyl alcohol (dihydrodicyclopentadienyl acrylate, DCPA), as described in DE-A 1 260 135, represents also a preferred polyfunctional, cross-linking monomer B12.

Especially, the polyfunctional, cross-linking monomer B12 is at least one chosen from the following list: allyl(meth)acrylate, divinylbenzene, diallylmaleate, diallylfumarate, diallylphthalate, triallylcyanurate, triallylisocyanurate and dihydrodicyclopentadienyl acrylate (DCPA), preferred chosen from allyl(meth)acrylate, divinylbenzene, diallylmaleate, diallylfumarate, diallylphthalate and dihydrodicyclopentadienyl acrylate (DCPA), especially preferred chosen from ally(meth)acrylate and dihydrodicyclopentadienyl acrylate (DCPA).

In a preferred embodiment, 1 to 2.5% by weight, preferably 1.5 to 2.1% by weight, based on the graft base B1, of dihydrodicyclopentadienyl acrylate (DCPA) are used as monomer B12 alone or in a mixture with one further of the above mentioned monomers B12, especially in mixture with allyl(meth)acrylate.

Furthermore, graft base B1 can comprise optionally one or more copolymerizable, monoethylenic unsaturated monomers B13, different from B11 and B12. Monomers B13 can for example be chosen from styrene, acrylonitrile, methylmethacrylate and vinylmethylether.

In a preferred embodiment, the at least one graft base B1 is obtained from emulsion polymerization of:
B11:90 to 99.9% by weight, preferably 97 to 99.5% by weight, based on the graft base B1, of at least one C₁-C₈ alkyl (meth)acrylate, preferable n-butyl-acrylate;
B12:0.1 to 10% by weight, preferably 0.5 to 3% by weight, most preferred 1 to 2.5% by weight, based on the graft base B1, of at least one polyfunctional, cross-linking monomer B12; chosen from isoprene, butadiene, chloroprene, alkylene glycol di(meth)acrylate, allyl(meth)acrylate, divinylbenzene, diallylmaleate, diallylfumarate, diallylphthalate and dihydrodicyclopentadienyl acrylate (DCPA), especially preferred allyl(meth)acrylate and/or d dihydrodicyclopentadienyl acrylate (DCPA);
wherein the sum of B11 and B12 equals 100% by weight of B1.

The graft base B1, comprising monomers B11, B12 and optionally B13, as well as its preparation is known and described in the literature, e.g. DE-A 28 26 925, DE-A 31 49 358 and DE-A 34 14 118.

The graft polymerization used to synthesize graft shell B2 (for example B2′ and B2″) is conveniently done in the same vessel like the emulsion polymerization done for the synthesis of the graft base B1. During the reaction additives, like emulsifiers, pH buffers and initiators can be added. The monomers of the graft shell, especially monomers B21 and B22 can be added at once to the reaction mixture or step-wise in several steps, preferably in a continuous way, added during polymerization. When monomers B21 and/or B22 are added in several steps typically a multi layered graft shell B2 is obtained.

Suitable emulsifiers, buffers and initiators are described in WO 2015/150223 and WO 2015/078751.

In a preferred embodiment, graft copolymer B (only one graft layer B2) comprises:
B1:50 to 70% by weight, preferably 55 to 65% by weight, often 58 to 65% by weight, based on the graft copolymer B, of at least one graft base (as described above);
B2 30 to 50% by weight, preferably 35 to 45% by weight, often 35 to 42% by weight, based on the graft copolymer B, of at least on graft shell B2, obtained from emulsion polymerization, in presence of at least one graft base B1, of:
   B21:50 to 95% by weight, preferably 65 to 80% by weight, more preferably 75 to 80% by weight, based on the graft base B2, of a monomer B21, chosen from styrene, alpha-methylstyrene or mixtures of styrene and at least one further monomer chosen from alpha-methylstyrene, p-methylstyrene and C₁-C₄-alkyl (meth)acrylate (e.g. methylmethacrylate, ethylmethacrylate), preferred chosen from styrene, alpha-methylstyrene or mixtures of styrene with alpha-methylstyrene or methylmethacrylate; and
   B22:5 to 50% by weight, preferably 20 to 35% by weight, often 20 to 25% by weight, based on the graft shell B2, of a monomer B22, chosen from acrylonitrile or mixtures of acrylonitrile and at least one further monomer chosen from methacrylonitrile, acrylamide, vinylmethylether, anhydrides of unsaturated carboxylic acids (e.g. maleic acid anhydride, phthalic acid anhydride) and imides of unsaturated carboxylic acids (e.g. N-substituted maleimide, like N-cyclohexylmaleimide and N-phenylmaleimide), preferred chosen from acrylonitrile or mixtures of acrylonitrile an methacrylontrile;
wherein the total sum of graft base B1 and graft shell B2 equals 100% by weight of the graft copolymer B.

In a preferred embodiment of the invention graft copolymer B (two layer graft shell comprising B2′ and B2″) comprises:
B1:50 to 70% by weight, preferably 60 to 70% by weight, based on the graft copolymer B, of at least one graft base B1, as described above;
B2′: 10 to 30% by weight, preferably 10 to 20% by weight, often 10 to 15% by weight, based on the graft copolymer B, of at least one graft shell B2′, which is obtained from emulsion polymerization, in presence of graft base B1, of:
   B21′: 100% by weight, based on graft shell B2′, of a monomer B21′, chosen from styrene, alpha-methylstyrene or a mixture of styrene and at least one further monomer chosen from alpha-methylstyrene, p-methylstyrene and C₁-C₄-alkyl (meth)acrylate (e.g. methylmethacrylate, ethylmethacrylate); and
B2″: 20 to 40% by weight, preferably 20 to 30% by weight, often 25 to 30% by weight, based on the graft copolymer B, of at least one graft shell B2″, which is also obtained from emulsion polymerization, in presence of the with B2′ grafted graft base B1, of:
   B21″: 50 to 95% by weight, preferably, 65 to 80% by weight, often 70 to 80% by weight, based on the graft shell B2″, of a monomer B21″, chosen from styrene, alpha-methylstyrene or mixtures of styrene and at least one further monomer chosen from alpha-methylstyrene, p-methylstyrene and C₁-C₄-alkyl (meth)acrylate (e.g. methylmethacrylate, ethylmethacrylate), preferred chosen from styrene, alpha-methylstyrene or mixtures of styrene and alpha-methylstyrene or methylmethacrylate; and
   B22″: 5 to 50% by weight, preferably 20 to 35% by weight, more preferably 20 to 30% by weight, based on the graft shell B2″, of at least one monomer B22″, chosen from acrylonitrile or mixtures of acrylonitrile and at least one further monomer chosen from methacrylonitrile, acrylamide, vinylmethylether, anhydrides of unsaturated carboxylic acids (e.g. maleic acid anhydride, phthalic acid anhydride) and imides of unsaturated carboxylic acids (e.g. N-substituted maleimide, like N-cyclohexylmaleimide and N-phenylmaleimide).

Preferably, monomers B21, B21′ and B21″ are styrene or mixtures of styrene and alpha-methylstyrene.

Preferably, monomers B22 and B22″ are acrylonitrile or mixtures of acrylonitrile and at least one further monomer chosen from methacrylonitrile, maleic acid anhydride, N-cyclohexylmaleimide, N-phenylmaleimide, more preferred acrylonitrile or mixtures of acrylonitrile and at least one further monomer chosen from methacrylonitrile and maleic acid anhydride.

Monomers B23 and B23″ may be chosen from copolymerizable, ethylenic unsaturated monomers such as C₁-C₆-alkyl methacrylates, C₉-C₂₀-alkyl methacrylates, and polyfunctional, cross-linking monomers selected from isoprene, butadiene, chloroprene, alkylene glycol di(meth)acrylate, allyl(meth)acrylate, divinylbenzene, diallylmaleate, diallylfumarate, diallylphthalate and dihydrodicyclopentadienyl acrylate (DCPA).

In a more preferred embodiment of the invention monomers B21, B21′ and B21″ are styrene and monomers B22 and B22′ are acrylonitrile.

The graft copolymer B (obtained as latex) typically has a weight-average particle diameter dw of 50 to 1000 nm, preferred 90 to 700 nm. The particle size of latex particles can be governed during synthesis by suitable means known in the literature, e.g. DE-A 28 26 925.

Typically the mean particle diameter can be measured by ultracentrifugation (e.g. described in W. Scholtan, H. Lange, Kolloid-Z. u. Z. Polymere 250, S. 782 bis 796, 1972) or using Hydrodynamic Chromatography HDC (e.g. described in W. Wohlleben, H. Schuch, “Measurement of Particle Size Distribution of Polymer Latexes”, 2010, Editors: L. Gugliotta, J. Vega, p. 130-153). The mean particle diameter d₅₀ represents the value of the particle size distribution curve, wherein 50% of the particles (e.g. polyacrylate latex) have a smaller diameter and the other 50% have a larger diameter, compared to the d₅₀ value. In similar way for example the doo values gives the particle diameter, wherein 90% of all particles have a smaller diameter. The mean particle size (mass mean, dw) can be also determined by turbidity measurement as described in Lange, Kolloid-Zeitschrift und Zeitschrift für Polymere, Band 223, Heft 1.

In one embodiment of the invention, the graft copolymer B is present in a mono-modal weight-average particle size distribution dw.

In an alternative embodiment of the invention, the graft copolymer B can, however, be present in a multimodal weight-average particle size distribution dw, more preferably in a bimodal weight-average particle size distribution dw, i.e. in form of a mixture of at least two different graft copolymers B-I and B-II, wherein graft copolymers B-I and B-II differ in their weight-average particle size dw.

Graft copolymer B especially comprises at least one of the graft copolymers B-I and B-II, where:
Graft copolymer B-I has a weight-average particle size dw from 50 to 180 nm, preferred 80 to 150 nm, often 90 to 100 nm (small size ASA rubber) and Graft copolymer B-II has a weight-average particle size dw from 200 to 800 nm, preferred 300 to 700 nm, often 400 to 600 nm (large size ASA rubber).

Suitable large size, cross-linked C₁-C₈alkyl (meth)acrylate polymer graft bases B1-II can be produced according to known procedures for the production of large size dispersion, conveniently via seeded polymerization, as described in DE 1 911 882 for the production of ASA polymers.

According to this method a small size, cross-linked acrylate latex (seed latex) having a mean particle size dw from 50 to 180 nm, preferred less than 120 nm, which is obtained from emulsion polymerization of C₁-C₈-alkyl (meth)acrylates, cross-linking monomers and optionally further comonomers, emulsifiers and possibly buffer, is subjected to a further polymerization reaction. The reaction conditions (Journal of Applied Polymer Science, Vol. 9 (1965), pages 2929 to 2938) are adjusted in way only allowing further growth of the present (seed) latex particles, without forming new latex particles. Normally an initiator is used. The particle size of the resulting graft copolymer B-II (large size rubber) can be adjusted by variation of the weight ratio of seed latex to monomers.

Graft copolymer B-II is preferably obtained by emulsion polymerization of styrene or alpha-Methylstyrene and acrylonitrile in presence of the previously prepared large size graft base B1-II.

In order to produce the inventive thermoplastic resins graft copolymers B-I and B-II can be combined, especially in step d (mixing of the components). The weight ratio of graft copolymers B-I and B-II can be varied in wide ranges. Preferably the graft copolymer is a mixture of graft copolymer B-I and B-II, wherein the weight ratio of graft copolymer B-I: graft copolymer B-II is from 90:10 to 10:90, preferably 80:20 to 20:80 and most preferably 70:30 to 35:65.

Preferably, the above described graft copolymers B-I and B-II are prepared and isolated separately. It is also possible to mix graft copolymers B-I and B-II after producing them separately and isolated them together.

It is also possible to obtain graft copolymers with different particle sizes, especially bimodal particle size distributions from 50 to 180 nm and 200 to 800 nm, via known agglomeration procedures. Graft copolymers with large and small size particles are for example described in DE-A 36 15 607.

In a preferred embodiment of the invention, the graft copolymer B has a weight-average particle diameter dw of at least 100 nm. It was found by the inventors that graft copolymers B having a weight-average particle diameter dw of at least 100 nm exhibit improved mechanical properties after being subjected to artificial weathering conditions. More preferable properties are obtained by graft copolymers B having a weight-average particle diameter dw of at least 300 nm, more preferably of at least 350 nm.

Furthermore, graft copolymers B having two or more different graft shells B2 can be used. Graft copolymers with multi-layer graft shells are for example described in EP-A 0111260 and WO 2015/078751.

Monomers B21 and B22 used for emulsion polymerization of graft copolymer B are preferably mixtures of styrene and acrylonitrile having a weight ratio of 95:5 to 50:50, often a weight ratio of 80:20 to 65:35.

In addition, a molecular weight regulator can be used for producing graft base B1 and/or for emulsion polymerization of at least one graft copolymer B, preferably using 0.01 to 2% by weight, often from 0.05 to 1% by weight (related to the total amount of monomers used for emulsion polymerization). Suitable molecular weight regulators are for example alkyl mercaptans, like n-dodecylmercaptan, t-dodecylmercaptan; dimeric alpha-methylstyrene and terpinolenes.

Suitable initiators for producing graft base B1 and/or for emulsion polymerization of at least one graft copolymer B are arbitrary initiators. Preferably at least one organic and/or inorganic peroxide compounds (comprising at least one peroxide group R—O—O—H and/or R—O—O—R) is used as initiator. Especially inorganic peroxide salts, like persulfate, perphosphate or perborate, of aluminum, sodium or potassium can be used. Most preferred are sodium and potassium persulfate.

In a preferred embodiment of the invention an inorganic peroxide salt, preferably inorganic persulfate salt, preferably sodium persulfate and/or potassium persulfate, is used for emulsion polymerization of graft copolymer B.

As emulsifier for the production of graft base B1 and/or emulsion polymerization of at least one graft copolymer B typical anionic emulsifiers can be used. Preferably, emulsifiers like alkyl sulfates, alkyl sulfonates, aryl alkyl sulfonates, soaps of saturated or unsaturated fatty acids as well as alkaline disproportionated or hydrated abietic acid or tall oil acids or mixtures thereof. Preferably emulsifiers comprising carboxylic groups (e.g. salts of C₁₀-C₁₈ fatty acids, disproportionated abietic acid or tall oil acids, emulsifiers according to DE-OS 36 39 904 and DE-OS 39 13 509) are used.

Typically, a suitable buffer is used for producing graft copolymer B, e.g. sodium carbonate or sodium bicarbonate. Suitable emulsifiers, buffers and initiators are also mentioned in WO 2015/150223 and WO 2015/078751.

Temperature during emulsion polymerization of graft copolymer B is generally from 25 to 160° C., preferably 40 to 90° C. Suitable emulsifiers are mentioned above. During reaction typical temperature management can be applied, like an isothermal process, preferably the polymerization is conducted in a way to keep the temperature difference between begin and end of the reaction less than 20° C., preferably less than 15 and most preferred less than 5° C.

The production of graft copolymers B, especially graft copolymers B-I and B-II, according to the invention is conducted via emulsion polymerization. Common embodiments of emulsion polymerization, in batch or continuous mode, are well known to a skilled person.

Especially monomers B2 for the graft shell, meaning monomers B21 and B22, are added separately or in form of a monomer mixture continuously to the graft base B2, in the right amounts and weight ratios. It is that the monomers are typically added to the graft base B1 in a way known to a skilled person.

### UV Absorber (Component C)

The thermoplastic molding composition P according to the invention comprises 0.1 to 4% by weight, based on the molding composition P, at least one UV absorber as component C.

The UV absorber component C comprises at least one organic or inorganic component having an UV absorption at least in a wavelength range≤380 nm, in particular in a wavelength range from 200 to 380 nm.

Known UV absorbers meeting the requirements with respect to UV absorption are no dyes within the meaning of the invention, i.e. are colorless and exhibit substantially no absorption of electromagnetic radiation in the visible wavelength range of from 380 nm to 780 nm. Such UV absorbers include 2-(2-hydroxyphenyl)-2H-benzotriazoles, for example known commercial hydroxyphenyl-2H-benzotriazoles and benzotriazoles as disclosed, for example in, U.S. Pat. Nos. 3,004,896; 3,055,896; 3,072,585; 3,074,910; 3,189,615; 3,218,332; 3,230,194; 4,127,586; 4,226,763; 4,275,004; 4,278,589; 4,315,848; 4,347,180; 4,383,863; 4,675,352; 4,681,905; 4,853,471; 5,268,450; 5,278,314; 5,280,124; 5,319,091; 5,410,071; 5,436,349; 5,516,914; 5,554,760; 5,563,242; 5,574,166; 5,607,987; 5,977,219 and 6,166,218.

Examples of UV absorbers include: 2-(2-hydroxy-5-methylphenyl)-2H-benzotriazole, 2-(3,5-di-t-butyl-2-hydroxyphenyl)-2H-benzo-triazole, 2-(2-hydroxy-5-t-butylphenyl)-2H-benzotriazole, 2-(2-hydroxy-5-tert-octylphenyl)-2H-benzotriazole, 5-chloro-2-(3,5-di-t-butyl-2-hydroxyphenyl)-2H-benzotriazole, 5-chloro-2-(3-t-butyl-2-hydroxy-5-methylphenyl)-2H-benzotriazole, 2-(3-sec-butyl-5-t-butyl-2-hydroxyphenyl)-2H-benzotriazole, 2-(2-hydroxy-4-octyloxyphenyl)-2H-benzotriazole, 2-(3,5-di-t-amyl-2-hydroxyphenyl)-2H-benzotriazole, 2-(3,5-bis-[alpha]-cumyl-2-hydroxyphenyl)-2H-benzo-triazole, 2-(3-t-butyl-2-hydroxy-5-(2-([omega]-hydroxy-octa-(ethyleneoxy) carbonyl-ethyl)-phenyl)-2H-benzotriazole, 2-(3-dodecyl-2-hydroxy-5-methylphenyl)-2H-benzotriazole, 2-(3-t-butyl-2-hydroxy-5-(2-octyloxycarbonyl)ethylphenyl)-2H-benzotriazole, dodecylated 2-(2-hydroxy-5-methylphenyl)-2H-benzotriazole, 2-(3-t-butyl-2-hydroxy-5-(2-octyloxycarbonyl-ethyl)phenyl)-5-chloro-2H-benzotriazole, 2-(3-tert-butyl-5-(2-(2-ethylhexyloxy)-carbonylethyl)-2-hydroxyphenyl)-5-chloro-2H-benzotriazole, 2-(3-t-butyl-2-hydroxy-5-(2-methoxycarbonyl-ethyl)phenyl)-5-chloro-2H-benzotriazole, 2-(3-t-butyl-2-hydroxy-5-(2-methoxycarbonyl-ethyl)phenyl)-2H-benzotriazole, 2-(3-t-butyl-5-(2-(2-ethylhexyloxy) carbonylethyl)-2-hydroxy-phenyl)-2H-benzotriazole, 2-(3-t-butyl-2-hydroxy-5-(2-isooctyloxycarbonylethyl)phenyl-2H-benzotriazole, 2,2′-methylene-bis(4-t-octyl-(6-2H-benzotriazol-2-yl) phenol), 2-(2-hydroxy-3-[alpha]-cumyl-5-t-octylphenyl)-2H-benzotriazole, 2-(2-hydroxy-3-t-octyl-5-[alpha]-cumylphenyl)-2H-benzotriazole, 5-fluoro-2-(2-hydroxy-3,5-di-[alpha]-cumylphenyl)-2H-benzotriazole, 5-chloro-2-(2-hydroxy-3,5-di-[alpha]-cumylphenyl)-2H-benzotriazole, 5-chloro-2-(2-hydroxy-3-[alpha]-cumyl-5-t-octylphenyl)-2H-benzotriazole, 2-(3-tert-butyl-2-hydroxy-5-(2-isooctyloxycarbonylethyl)phenyl)-5-chloro-2H-benzotriazole, 5-trifluoromethyl-2-(2-hydroxy-3-[alpha]-cumyl-5-t-octylphenyl)-2H-benzotriazole, 5-trifluoromethyl-2-(2-hydroxy-5-t-octylphenyl)-2H-benzotriazole, 5-trifluoromethyl-2-(2-hydroxy-3,5-di-t-octylphenyl)-2H-benzotriazole, methyl 3-(5-trifluoromethyl-2H-benzotriazol-2-yl)-5-t-butyl-4-hydroxyhydrocinnamate, 5-butylsulfonyl-2-(2-hydroxy-3-[alpha]-cumyl-5-t-octylphenyl)-2H-benzotriazole, 5-trifluoromethyl-2-(2-hydroxy-3-[alpha]-cumyl-5-t-butylphenyl)-2H-benzotriazole, 5-trifluoromethyl-2-(2-hydroxy-3,5-di-t-butylphenyl)-2H-benzotriazole, 5-trifluoromethyl-2-(2-hydroxy-3,5-di-[alpha]-cumylphenyl)-2H-benzotriazole, 5-butylsulfonyl-2-(2-hydroxy-3,5-di-t-butylphenyl)-2H-benzotriazole and 5-phenylsulfonyl-2-(2-hydroxy-3,5-di-t-butylphenyl)-2H-benzotriazole.

As a disadvantage, several of these UV stabilizers are classified as hazardous according to current EU regulations for Classification, Labeling and Packaging of Chemical Substances. 2-(2H-benzotriazole-2-yl)-4-methylphenol is classified since it is very toxic to aquatic life with long lasting effects and may cause an allergic skin reaction. Moreover, it would be advantageous to reduce the amount of UV stabilizers not only from an ecological, but also from an economical point of view.

In view of this, it is desired to reduce the amount of common UV stabilizers such as 2-(2H-benzotriazole-2-yl)-4-methylphenol in polymer compositions. It has been surprisingly found by the present inventors that conventional UV absorber compounds, such as UV absorber compounds comprising benzotriazole moieties, in particular 2-(2H-benzotriazole-2-yl)-4-methylphenol, may be partially or fully replaced by absorber components C comprising at least one dye having an UV absorption at least in a wavelength range≤380 nm, at least one white pigment and/or at least one black pigment when used in thermoplastic molding compositions P according to the present invention.

According to the invention, the UV absorber component C therefore at least partially consists of at least one organic or inorganic component selected from at least one black pigment, white pigment and/or at least one dye having an UV absorption at least in a wavelength range≤380 nm, preferably 100 nm to 380 nm, more preferably 200 nm to 380 nm, and in particular 250 nm to 380 nm. More preferably, the UV absorber component C at least partially consists of at least one dye having an UV absorption at least in a wavelength range≤380 nm, at least one white pigment and/or at least one black pigment. In a further preferred embodiment, the UV absorber component C at least partially consists of at least one dye having an UV absorption at least in a wavelength range≤380 nm and carbon black and/or at least one white pigment. In a further preferred embodiment, the UV absorber component C at least partially consists of at least one dye having an UV absorption at least in a wavelength range≤380 nm selected from red, orange and yellow dyes, in particular yellow dyes. However, the composition may comprise further dyes, colorants and/or pigments, which do not meet these specifications in order to adjust the visual impression to the consumer specifications.

Suitable pigments include carbon black and titanium dioxide.

Suitable dyes include, for example, Paliotol® Yellow K 1090 (BASF SE, CAS-No.: 30125-47-4), Sicotan® Yellow K 2011 FG (BASF SE, CAS-No.: 68186-90-3), Sicopal® Yellow K 1160 FG (BASF SE, CAS-No.: 14059-33-7).

It was found by the present inventors, that conventional UV absorbers, in particular, compounds comprising benzotriazole moieties represented by the following formula (I) and mixtures thereof may be partially of fully replaced as UV absorber component C by at least one dye having an UV absorption at least in a wavelength range≤380 nm, at least one white pigment and/or at least one black pigment:

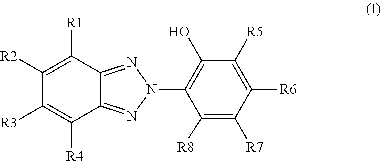

wherein
R1, R2, R3, R4, R5, R6, R7, and R8 are independently selected from hydrogen atoms, halogen atoms and alkyl groups having 1 to 5 carbon atoms.

In particular, 2-(2H-benzotriazole-2-yl)-4-methylphenol (CAS-No.: 2440-22-4, commercially available as Tinuvin® P from BASF SE, Germany) represented by the following formula (I-a):

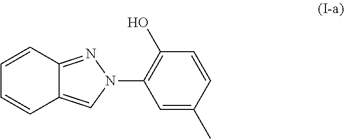 [SMILES: Cc1ccc(O)c(-n2cc3ccccc3n2)c1]

may advantageously be replaced as UV absorber component C according to the invention.

Further suitable UV absorbers to be replaced according to the invention include 2-(5-chloro-2H-benzotriazole-2-yl)-6-(1,1-dimethylethyl)-4-methylphenol (Tinuvin® 326) represented by the following formula (I-b):

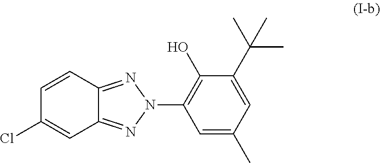 [SMILES: Cc1cc(-n2nc3ccc(Cl)cc3n2)c(O)c(C(C)(C)C)c1]

In one embodiment of the invention, the UV absorber component C comprises compounds of formulae (I), (I-a) and/or (I-b). Preferably, the UV absorber component C comprises the compound of formula (I-a).

In one embodiment of the invention, compounds comprising benzotriazole moieties are partially, and more preferably completely, replaced as UV absorbers by organic or inorganic components selected from at least one black pigment, white pigment and/or at least one dye having an UV absorption at least in a wavelength range≤380 nm. In a preferred embodiment, the thermoplastic molding composition P comprises≤0.2% by weight, based on the thermoplastic molding composition P, of 2-(2H-benzotriazole-2-yl)-4-methylphenol (Tinuvin® P) represented by formula (I-a), 2-(5-chloro-2H-benzotriazole-2-yl)-6-(1,1-dimethylethyl)-4-methylphenol (Tinuvin® 326) represented by formula (I-b) and/or compounds comprising benzotriazole moieties represented by the general formula (I).

In one embodiment, the amount of components of formulae (I-a), (I-b) and/or (I) are each ≤0.05% by weight, even more preferably ≤0.01% by weight, and often ≤0.001%, based on the total weight of the thermoplastic molding composition P.

The weight ratio of replacement is preferably in the range of from 1:0.5 to 1:10, i.e. 1 part by weight of benzotriazole UV absorber is replaced by 0.5 to 10 parts by weight of the at least one black pigment, white pigment and/or at least one dye having an UV absorption at least in a wavelength range≤380 nm. More preferably, the weight ratio is in the range from 1:1 to 1:5, in particular from 1:1.2 to 1:4.

In one embodiment of the invention, the UV absorber component C preferably consists of at least one organic or inorganic component selected from at least one black pigment, white pigment and/or at least one dye having an UV absorption at least in a wavelength range≤380 nm or a mixture of at least two of the afore mentioned. In a preferred embodiment, the UV absorber component C consists a mixture of at least one black pigment, white pigment and least one dye having an UV absorption at least in a wavelength range≤380 nm. This means that preferably no UV absorber component C according to formulae (I), (I-a) and/or (I-b) is present in the thermoplastic molding composition P. More preferably, no other UV absorber component C is present in the thermoplastic molding composition P.

In an alternative embodiment of the invention, compounds comprising benzotriazole moieties are only partially, replaced by organic or inorganic components selected from at least one black pigment, white pigment and/or at least one dye having an UV absorption at least in a wavelength range≤380 nm, wherein the thermoplastic molding composition P comprises from 0.05 to 0.2% by weight, preferably 0.07 to 0.15% by weight, based on the thermoplastic molding composition P, of 2-(2H-benzotriazole-2-yl)-4-methylphenol (Tinuvin® P) represented by formula (I-a), 2-(5-chloro-2H-benzotriazole-2-yl)-6-(1,1-dimethylethyl)-4-methylphenol (Tinuvin® 326) represented by formula (I-b) and/or compounds comprising benzotriazole moieties represented by the general formula (I).

Black pigments are preferably used in amounts of at least 0.05 wt.-%, more preferably at least 0.1 wt.-%, based on the total weight of the thermoplastic molding composition P. Typically, the amount of black pigments does not exceed 2.5 wt.-%, often does not exceed 2 wt.-%, based on the total weight of the thermoplastic molding composition P.

White pigments are preferably used in amounts of at least 0.5 wt.-%, more preferably at least 1.0 wt.-%, based on the total weight of the thermoplastic molding composition P. Typically, the amount of white pigments does not exceed 3 wt.-%, often does not exceed 2.5 wt.-% based on the total weight of the thermoplastic molding composition P.

Dyes having an UV absorption at least in a wavelength range≤380 nm are in total preferably used in amounts of at least 0.05 wt.-%, more preferably at least 0.1 wt.-%, based on the total weight of the thermoplastic molding composition P. Typically, the amount of dyes in total does not exceed 3 wt.-%, often does not exceed 2.7 wt.-% based on the total weight of the thermoplastic molding composition P.

In mixtures of dyes with black pigments and/or white pigments, black pigments are preferably present in amounts of at least 0.1 wt.-%, white pigments are preferably present in amounts of at least 0.5 wt.-%, and dyes having an UV absorption at least in a wavelength range≤380 nm are preferably used in amounts of at least 0.5 wt.-%, in order to be effective as UV absorber. Thus, mixtures of dyes with black pigments and/or white pigments, black pigments comprising less than 0.1 wt.-% black pigments and/or less than 0.5 wt.-% white pigments, and less than 0.5 wt.-% in total of dyes having an UV absorption at least in a wavelength range≤380 nm, based on the total weight of the thermoplastic molding composition P, are not within the scope of the present invention. For example, small amounts of white pigments and/or black pigments are often used to adjust the color appearance to consumer specifications.

From the viewpoint of UV stabilization, the UV absorber component C preferably comprises at least one dye having an UV absorption at least in a wavelength range ≤380 nm. Optionally, the UV absorber component C comprises additionally at least one black pigment and/or at least one white pigment.

### Further Additives (Component D)

The thermoplastic molding composition P according to the invention comprises 0 to 10% by weight, often 0.1 to 8% by weight, based on the molding composition P, at least one further additive as optional component D, wherein the additive(s) D are different from the components C, which are comprised in the thermoplastic molding composition P.

As used herein, the one or more further additives D may be any additives usable in molding composition P. Suitable added additives D include all substances customarily employed for processing or finishing the polymers. For example a further additive D may be selected from the group consisting of light stabilizers, antioxidants, co-stabilizers plasticizers, lubricants, demolding agents, anti-dripping agents, matting agents, and fillers. These further added substances may be admixed at any stage of the manufacturing operation, but preferably at an early stage in order to profit early on from the stabilizing effects (or other specific effects) of the added substance.

Additives D may be added in form of master batches comprising additives D in a polymer matrix. In a preferred embodiment, the additives D are added in form of a master batch comprising 10 to 70% by weight, preferably 20 to 60% by weight, based on the total amount of the master batch, of additives D or mixtures thereof and 30 to 90% by weight, preferably 40 to 80% by weight, based on the total amount of the master batch, a copolymer of an vinylaromatic olefin and acrylonitrile as matrix polymer. Preferably, the matrix polymer is selected from poly(styrene-acrylonitrile) (SAN), poly(α-methyl styrene/acrylonitrile) (AMSAN), and/or poly(styrene-methyl methacrylate) (SMMA).

Examples of additives D include, for example, light stabilizers, in particular hindered amine light stabilizers, antioxidants, in particular phenolic antioxidants, antistatic agents, antioxidants, flame retardants, stabilizers for improving thermal stability, stabilizers for increasing photostability, stabilizers for enhancing hydrolysis resistance and chemical resistance, anti-thermal decomposition agents and in particular lubricants that are useful for production of molded bodies/articles.

Examples of suitable antistatic agents include amine derivatives such as N,N-bis(hydroxyalkyl)alkylamines or alkyleneamines, polyethylene glycol esters, copolymers of ethylene oxide glycol and propylene oxide glycol (in particular two-block or three-block copolymers of ethylene oxide blocks and propylene oxide blocks), and glycerol mono- and distearates, and mixtures thereof.

Examples of suitable flame retardants that may be used include the halogen-containing or phosphorus-containing compounds known to the person skilled in the art, magnesium hydroxide, and also other commonly used compounds, or mixtures thereof.

Examples of suitable light stabilizers different from component C include various substituted resorcinols, salicylates, benzophenones, vitamin E and compounds having analogous structures and also butylated condensation products of p-cresol and dicyclopentadiene. Other suitable compounds include, for example, thiocarboxylic esters. Also usable are C₆-C₂₀ alkyl esters of thiopropionic acid, in particular the stearyl esters and lauryl esters. It is also possible to use the dilauryl ester of thiodipropionic acid (dilauryl thiodipropionate), the distearyl ester of thiodipropionic acid (distearyl thiodipropionate) or mixtures thereof.

Suitable matting agents include not only inorganic substances such as talc, glass beads or metal carbonates (for example MgCO₃, CaCO₃) but also polymer particles, in particular spherical particles having diameters D₅₀ greater than 1 μm, based on, for example, methyl methacrylate, styrene compounds, acrylonitrile or mixtures thereof. It is further also possible to use polymers comprising copolymerized acidic and/or basic monomers.

Examples of suitable antidrip agents include polytetrafluoroethylene (Teflon) polymers and ultrahigh molecular weight polystyrene (weight-average molar mass Mw above 2,000,000).

Examples of fibrous/pulverulent fillers include carbon or glass fibers in the form of glass fabrics, glass mats, or filament glass rovings, chopped glass, glass beads, and wollastonite, particular preference being given to glass fibers. When glass fibers are used they may be finished with a sizing and a coupling agent to improve compatibility with the blend components. The glass fibers incorporated may either take the form of short glass fibers or else continuous filaments (rovings).

Examples of suitable particulate fillers include amorphous silica, magnesium carbonate, powdered quartz, mica, bentonites, talc, feldspar or, in particular, calcium silicates, such as wollastonite, and kaolin.

Suitable lubricants and demolding agents include stearic acids, stearyl alcohol, stearic esters, polyolefin waxes and/or generally higher fatty acids, derivatives thereof and corresponding fatty acid mixtures comprising 1 to 45 carbon atoms. In a further preferred embodiment the composition comprises amide compounds having the formula R¹—CONH—R², wherein R¹ and R² are each independently selected from aliphatic, saturated or unsaturated hydrocarbon groups having 1 to 30 carbon atoms, preferably 12 to 24 carbon atoms, in particular 16 to 20 carbon atom. In a further preferred embodiment of the invention, the composition may additionally comprise fatty acid ester compounds having the formula R³—CO—OR⁴, wherein R³ and R⁴ are each independently selected from aliphatic, saturated or unsaturated hydrocarbon groups having 1 to 45 carbon atoms, preferably 15 to 40 carbon atoms, in particular 25 to 35 carbon atoms. Also particularly suitable is ethylene-bis(stearamide).

In a further preferred embodiment, the thermoplastic polymer composition P may comprise an organic, inorganic or mixed phosphate, in particular an alkaline metal or earth alkaline metal phosphate such as Ca₃(PO₄)₂ and/or an organophosphate having alkyl or aryl groups comprising 1 to 12 carbon atoms. These phosphates may be conveniently added in form of a masterbatch, e.g. in combination with polyolefin waxes and/or olefin/styrene copolymers.

The thermoplastic molding composition P may also comprise dyes, pigments, or colorants as optional component D, which are different from the UV absorber component C described herein. In particular, dyes, pigments, or colorants are suitable, which do not exhibit an UV absorption at least in a wavelength range ≤380 nm, in particular in the range of from 250 to 380 nm. These dyes are typically used to adjust the visual impression of the molding composition P to the consumer specifications.

In one embodiment of the invention, the thermoplastic molding composition P may preferably comprise 0.1 to 1% by weight, preferably 0.15 to 0.9% by weight, more preferably 0.2 to 0.8%, often 0.3 to 0.7% by weight, based on the molding composition P, of at least one hindered amine light stabilizer as component D.

The thermoplastic molding composition P may comprises at least one hindered amine light stabilizer as component D preferably selected from compounds having the following formula (II):

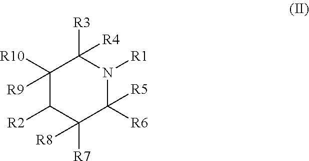

wherein
R1 represents a hydrogen atom or an alkyl group having 1 to 3 carbon atoms;
R2 represents a hydrocarbon group having 5 to 30 carbon atoms, wherein the hydrocarbon group preferably comprises at least one hetero atom selected from N and O; and
R3, R4, R5, R6, R7, R8, R9, and R10 independently represent hydrogen atoms or alkyl groups having 1 to 5 carbon atoms;
and mixtures of hindered amine light stabilizer as components D represented by formula (II).

Hindered amine light stabilizers (HALS) are generally known in the art. Known representatives for example bis-(2,2,6,6-tetramethylpiperidyl) include sebacate, bis-(1,2,2,6,6-pentamethylpiperidyl) sebacate, n-butyl-3,5-di-tert.butyl-4-hydroxybenzyl malonic acid bis-(1,2,2,6,6-pentanemethylpiperidyl) ester, condensation product of 1-hydroxyethyl-2,2,6,6-tetramethyl-4-hydroxypiperidine and succinic acid, condensation product of N,N′-(2,2,6,6-tetra-methylpiperidyl)-hexamethylenediamine and 4-tert-octylamino-2,6-dichloro-s-triazine, tris-(2,2,6,6-tetramethylpiperidyl)-nitrilotriacetate, tetrakis-(2,2,6,6-tetramethyl-4-piperidyl)1,2,3,4-butanetetracarboxylate, 1,1′(1,2-ethanediyl)-bis-(3,3,5,5-tetramethylpiperazinone), bis(1-octyloxy-2,2,6,6-tetramethylpiperidin-4-yl) sebacate, 1-(2-hydroxy-2-methylpropoxy)-4-octa-decanoyloxy-2,2,6,6-tetramethylpiperidine.

In a preferred embodiment, the at least one hindered amine light stabilizer as component D is selected from compounds having the following formula (II-a):

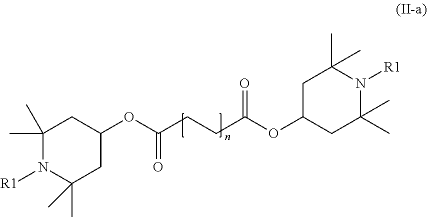

wherein
R1 represents independently from each other —H or —CH₃; and
n represents an integer from 1 to 8, preferably from 3 to 5, in particular 4;
   and mixtures thereof.

In a preferred embodiment, both substituents R1 are identical. More preferably, both substituents R1 represent a methyl group —CH₃.

Particular preferred representatives of hindered amine light stabilizer components D according to formula (II-a) include bis(2,2,6,6-tetramethyl-4-piperidyl)sebacat (CAS-No.: 52829-07-9), and bis(1,2,2,6,6-pentamethyl-4-piperidyl)sebacat (CAS-No.: 41556-26-7). The most preferred hindered amine light stabilizer component D according to formula (II-a) is bis(2,2,6,6-tetramethyl-4-piperidyl) sebacat, which is commercially available as Tinuvin® 770 from BASF SE, Germany.

In a preferred embodiment of the invention, the weight ratio of the at least one hindered amine light stabilizer component D to the at least one UV absorber component C (weight ratio HALS-D:C) ranges from 1:5 to 5:1, more preferably from 1:2 to 2:1, further more preferably 1:1.2 to 1.2:1. In a particular preferred embodiment of the invention, the weight ratio of the at least one hindered amine light stabilizer component HALS-D to the at least one UV absorber component C (weight ratio HALS-D:C) is about 1:1.

In one embodiment of the invention, the thermoplastic molding composition P may comprise 0.01 to 1% by weight, preferably 0.03 to 0.9% by weight, more preferably 0.04 to 0.8%, often 0.05 to 0.7% by weight, based on the molding composition P, of at least one antioxidant as component D.

The thermoplastic molding composition P may comprises at least one antioxidant as component D, preferably selected from sterically hindered phenolic antioxidants of the general formula (III) and mixtures thereof:

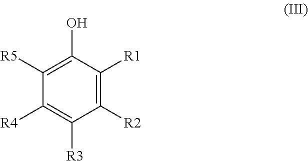

wherein
R1 to R5 independently represent hydrogen atoms or alkyl groups having 1 to 70 carbon atoms, wherein the hydrocarbon group optionally comprises at least one hetero atom selected from O and S, and wherein at least one of the substituents R1 and R5 represents a hydrocarbon group having at least 3 carbon atoms.

Particular preferred representatives of sterically hindered phenolic antioxidants as component D include octadecyl 3-(3,5-di-tert-butyl-4-hydroxyphenyl) propionate (CAS-No.: 2082-79-3, commercially available as Irganox® 1076 from BASF SE, Germany), pentaerythritol tetrakis[3-[3,5-di-tert-butyl-4-hydroxyphenyl]propionate (CAS-No.: 6683-19-8, commercially available as Irganox® 1010 from BASF SE, Germany), ethylenebis(oxyethylene)bis-(3-(5-tert-butyl-4-hydroxy-m-tolyl)-propionate) (CAS-No.: 36443-68-2, commercially available as Irganox® 245 from BASF SE, Germany), 4,4′-thiobis(2-(tert-butyl)-5-methylphenol) (CAS-No.: 96-69-5, commercially available as Rütenol® BB12P and Santonox® R), poly(dicyclopentadiene-co-p-cresol) (butylated reaction product of p-cresol and dicyclopentadiene, preferably with an average molecular weight 650 g/mol, CAS-No.: 68610-51-5, commercials available as Wingstay® L from Omnova Solutions), pentaerythritol tetrakis[3-[3,5-di-tert-butyl-4-hydroxyphenyl]propionate (CAS-No. 2082-79-3), ethylenebis(oxyethylene)bis-(3-(5-tert-butyl-4-hydroxy-m-tolyl)-propionate) (CAS-No. 36443-68-2). Particular preferred are pentaerythritol tetrakis[3-[3,5-di-tert-butyl-4-hydroxyphenyl]propionate (CAS-No. 2082-79-3), ethylenebis(oxyethylene)bis-(3-(5-tert-butyl-4-hydroxy-m-tolyl)-propionate) (CAS-No. 36443-68-2), 4,6-bis(dodecylthiomethyl)-o-cresol (CAS-No. 110675-26-8), 4,6-bis(dodecylthiomethyl)-o-cresol (CAS-No. 110675-26-8), and mixtures thereof.

The composition may also comprise antioxidants different from hindered phenolic antioxidants described above. Examples of suitable antioxidants include sterically hindered monocyclic or polycyclic phenolic antioxidants different from component hindered phenolic antioxidants described above which may comprise various substitutions and may also be bridged by substituents. These include not only monomeric but also oligomeric compounds, which may be constructed of a plurality of phenolic units. Hydroquinones and hydroquinone analogs are also suitable, as are substituted compounds, and also antioxidants based on tocopherols and derivatives thereof. It is also possible to use mixtures of different antioxidants. It is possible in principle to use any compounds which are customary in the trade or suitable for styrene copolymers.

In addition to the phenolic antioxidants cited above by way of example, it is also possible to use so-called co-stabilizers, in particular phosphorus- or sulfur-containing co-stabilizers. These phosphorus- or sulfur-containing co-stabilizers are known to those skilled in the art and can be used alone or in combination with each other.

### Preparation of the Molding Composition P

The method according of the present invention may have any procedural steps suitable for conducting the claimed method.

In a preferred embodiment, the step of compounding the components comprises at least the following steps:
(i) providing the components A to C and optionally component D in the predetermined amounts to an optionally heatable mixing device; and
(ii) blending the components A to C and—if present—component D in the optionally heatable mixing device at temperatures above the glass transition point of the components A to C to obtain the molding composition P.

Optionally, a step in which a homogenous particulate material mixture is prepared from the components A to D may be carried out prior to step (ii). However, also when provided to the optionally heatable mixing device without previous mixing, a homogenous mixing is typically achieved in the optionally heatable mixing device.

Each of components A to D—as far as solid—may be provided in form of particulate materials having different particle sizes and particle size distributions (e.g., as pellets, granules and/or powders).

The components A to D may be provided to a mixing device in the required amounts and weight ratios as previously indicated and optionally mixed prior to the blending step (ii) in order to obtain a homogenous particulate material mixture. In a preferred embodiment, this may require 1 to 60, preferably 1 to 20, in particular 2 to 10 minutes, depending to the amount of particulate material to be mixed.

The thus obtained homogenous particulate material mixture is then transferred to an optionally heatable mixing apparatus and blended therein, producing a substantially liquid-melt polymer mixture.

“Substantially liquid-melt” means that the polymer mixture, as well as the predominant liquid-melt (softened) fraction, may further comprise a certain fraction of solid constituents, examples being unmelted fillers and reinforcing material such as glass fibers, metal flakes, or else unmelted pigments, colorants, etc. “Liquid-melt” means that the polymer mixture is at least of low fluidity, therefore having softened at least to an extent that it has plastic properties.

Mixing apparatuses used are those known by the person skilled in the art. Components A to C, and—where included—D may be mixed, for example, by joint extrusion, kneading, or rolling, the aforementioned components necessarily having been isolated from the aqueous dispersion or from the aqueous solution obtained in the polymerization.

Examples of mixing apparatus for implementing the method include discontinuously operating, heated internal kneading devices with or without RAM, continuously operating kneaders, such as continuous internal kneaders, screw kneaders with axially oscillating screws, Banbury kneaders, furthermore extruders, and also roll mills, mixing roll mills with heated rollers, and calenders.

A preferred mixing apparatus used is an extruder or a kneader. Particularly suitable for melt extrusion are, for example, single-screw or twin-screw extruders. A twin-screw extruder is preferred. In some cases the mechanical energy introduced by the mixing apparatus in the course of mixing is enough to cause the mixture to melt, meaning that the mixing apparatus does not have to be heated. Otherwise, the mixing apparatus is generally heated.

The temperature is guided by the chemical and physical properties of the components A to D, and should be selected such as to result in a substantially liquid-melt polymer mixture. On the other hand, the temperature is not to be unnecessarily high, in order to prevent thermal damage of the polymer mixture. The mechanical energy introduced may, however, also be high enough that the mixing apparatus may even require cooling. Mixing apparatus is operated customarily at 150 to 400, preferably 170 to 300° C.

In a preferred embodiment, a heat able twin-screw extruder and a speed of 50 to 150 rpm, preferably 60 to 100 rpm is employed. In a preferred embodiment, an extruding temperature of 170 to 270° C., preferably 210 to 260° C. is employed to obtain the molding composition P. The molding composition P may be directly used, e.g. in molding processes, preferably injection molding processes, or may be processed to form granules which may be subjected to molding processes afterwards. The molding processes are preferably carried out at temperatures of 170 to 270° C., in particular 210 to 260° C. to result in a molded article.

Processing may be carried out using the known processes for thermoplastic processing, in particular production may be effected by thermoforming, extruding, injection molding, calendaring, blow molding, compression molding, press sintering, deep drawing or sintering, preferably by injection molding.

### Application

The thermoplastic molding composition P are used for producing molded articles for numerous applications. In view of the improved weathering stability, exterior applications or applications with exposure to UV irradiation are particular preferred. Said molded articles comprising the thermoplastic molding composition P may advantageously include, for example, components or articles for electronic devices, household goods and exterior and/or interior automotive parts, in particular for the manufacture of visible components or articles. A preferred application is the use of exterior automotive parts such as front grills or side mirrors.

The invention is further illustrated by the examples and patent claims.

### EXAMPLES

### Components

Component AB-1: Polymer mixture of:
   33.5% by weight of styrene/acrylonitrile (SAN) copolymer with a styrene/acrylonitrile weight ratio S/AN of 65/35 and a viscosity number VN of 80, measured at 23° C. in 0.5% methyl ethyl ketone solution, as component A,
   4.6% by weight of styrene/acrylonitrile (SAN) copolymer with a styrene/acrylonitrile weight ratio S/AN of 76/24 and a viscosity number VN of 64, measured at 23° C. in 0.5% methyl ethyl ketone solution, as component A,
   27.2% by weight of alpha-methylstyrene/acrylonitrile (AMSAN) copolymer as component A,
   32.4% by weight of a bimodal ASA graft copolymer as component B, 2.0% by weight of carbon black as component C,
   and
   0.3% by weight of additives (plasticizers, demolding agents) as component D.
Component AB-2: Polymer mixture of:
   10.3% by weight of styrene/acrylonitrile (SAN) copolymer with a styrene/acrylonitrile weight ratio S/AN of 65/35 and a viscosity number VN of 80, measured at 23° C. in 0.5% methyl ethyl ketone solution, as component A,
   53.6% by weight of styrene/acrylonitrile (SAN) copolymer with a styrene/acrylonitrile weight ratio S/AN of 65/35 and a viscosity number VN of 64, measured at 23° C. in 0.5% methyl ethyl ketone solution, as component A,
   35.1% by weight of a bimodal ASA graft copolymer as component B, and
   1.0% by weight of additives (plasticizers, demolding agents) as component D.
Component C-1:2-(2H-Benzotriazole-2-yl)-4-methylphenol (CAS-No. 2440-22-4), UV stabilizer having a UV absorption maximum at 301 nm and 341 nm (measured in chloroform with a concentration of 10 mg/l, ε=16′150 I/mol·cm) available as Tinuvin® P from BASF SE, Germany.
Component C-2: Carbon Black (CAS-No. 1333-86-4, Black Pearls 880, Cabot Corp.).
Component C-3: Heliogen® Green (BTC Europe, CAS-No.: 132-53-5).
Component C-4: Sicopal® Yellow K 1160 FG (BASF SE, CAS-No.: 14059-33-7).
Component C-5: TiO₂ (CAS-No. 13463-67-7, Kronos® 2220, Kronos).
Compound C-6: Sicopal® Blue K 3610 (BASF SE).
Compound C-7: Ultramarinviolett 11D.
Component D-1: Bis(2,2,6,6-tetramethyl-4-piperidyl) sebacat (CAS-No. 52829-07-9), HALS available as Tinuvin® 770 from BASF SE, Germany.

### Preparation

Thermoplastic molding compositions were prepared from the above described constituents by mixing in an twin screw extruder (Model ZSK-30, Coperion GmbH, Germany) at Tm=250° C. according to the specific weight ratios given in Table 1 and Table 2.

Various sets of Sample plaques have been prepared via injection molding (Tm: 250° C.).

Thermoplastic molding compositions with different UV absorbers as component C were prepared. The compositions are given in Table 1.

TABLE 1
Examples 1 to 4; Ex. 1 and 2 include 2 wt.-% of carbon
black as constituent of the polymer composition AB-1.

| Component [wt.-%] | Ex. 1 | Ex. 2 | Ex. 3 | Ex. 4 |
|---|---|---|---|---|
| AB-1 | 99 | 99.5 | — | — |
| AB-2 | — | — | 97.49 | 97.99 |
| C-1 | 0.5 | — | 0.5 | — |
| C-2 | — | — | 0.07 | 0.07 |
| C-3 | — | — | 0.92 | 0.92 |
| C-4 | — | — | 0.5 | 0.5 |
| C-5 | — | — | 0.02 | 0.02 |
| D-1 | 0.5 | 0.5 | 0.5 | 0.5 |

Several test specimens (produced according to ISO 294 in a mold family at a melt temperature of 250° C. and at a mold temperature of 60° C.) of the compositions according to Ex. 1 to 4 were prepared and subjected to Xenotest 1200 weathering according to ISO 4892/2, Method A, external.

The impact strength on un-notched test specimen was measured for Ex. 1 and Ex. 2 in a pendulum impact test according to ISO 180 after the weathering times specified in Table 2.

TABLE 2
Impact Strength an after artificial weathering of Examples 1 and 2.

| Weathering time in h | Ex. 1 | Ex. 2 |
|---|---|---|
| 0 | 180 | 160 |
| 400 | 140 | 140 |
| 800 | 100 | 110 |
| 1200 | 80 | 85 |

The test specimen were also evaluated with respect to surface gloss. Initial and residual gloss after artificial weathering was determined according to DIN EN ISO 2813 with measuring angle 60°. The results of the evaluation are given in Table 3.

TABLE 3
Residual gloss (%) after artificial weathering of Examples 1 to 4.

| Weathering time in h | Ex. 1 | Ex. 2 | Ex. 3 | Ex. 4 |
|---|---|---|---|---|
| 0 | 94 | 93 | 95 | 95 |
| 400 | 85 | 85 | 88 | 88 |
| 800 | 83 | 82 | 79 | 79 |
| 1200 | 83 | 83 | 78 | 78 |

Furthermore, the test specimen were evaluated with respect to color shift dE. Initial and residual color after artificial weathering was determined by color measurements according to DIN 6174. The test results are summarized in Table 5.

TABLE 5
Color shift dE after artificial weathering of Examples 3 and 4 .

| Weathering time in h | Ex. 3 | Ex. 4 |
|---|---|---|
| 0 | 0 | 0 |
| 2000 | 4 | 4.5 |
| 4000 | 6 | 7 |
| 6000 | 7 | 10 |

Thermoplastic molding compositions with different UV absorbers as component C were prepared. The compositions are shown in Table 6.

TABLE 6
Examples 5 and 6.

| Component [wt.-%] | Ex. 5 | Ex. 6 |
|---|---|---|
| AB-2 | 95.41 | 95.91 |
| C-1 | 0.5 | — |
| C-2 | 0.02 | 0.02 |
| C-5 | 1.25 | 1.25 |
| C-6 | 1.19 | 1.19 |
| C-7 | 1.13 | 1.13 |
| D-1 | 0.5 | 0.5 |

Test specimens (produced according to ISO 294 in a mold family at a melt temperature of 250° C. and at a mold temperature of 60° C.) of the compositions according to Ex. 5 and 6 were prepared and subjected to Xenotest 1200 weathering according to ISO 4892/2, Method A, external.

The test specimen were evaluated with respect to surface gloss. Initial and residual gloss after artificial weathering was determined according to DIN EN ISO 2813 with measuring angle 60°. The results of the evaluation are given in Table 7.

TABLE 7
Residual gloss (%) after artificial weathering of Examples 5 and 6.

| Weathering time in h | Ex. 5 | Ex. 6 |
|---|---|---|
| 0 | 96 | 95 |
| 1000 | 85 | 83 |

Furthermore, the test specimen were evaluated with respect to color shift dE. Initial and residual color after artificial weathering was determined by color measurements according to DIN 6174. The test results are summarized in Table 8.

TABLE 8
Color shift dE after artificial weathering of Examples 5 and 6.

| Weathering time in h | Ex. 5 | Ex. 6 |
|---|---|---|
| 0 | 0 | 0 |
| 2000 | 3 | 4 |
| 4000 | 4.5 | 5.5 |

The experimental data of tables 1 to 8 show that the UV absorber 2-(2H-benzotriazole-2-yl)-4-5 methylphenol may be completely substituted by dyes and/or pigments according to the invention without substantial deterioration of the mechanical characteristics (impact strength) and optical characteristics (surface gloss and color shift dE) of the thermoplastic molding composition. Similar results are observed for thermoplastic molding compositions in accordance with the present invention comprising the constituents A to D as described herein.

1. A thermoplastic molding composition P, comprising:
AB: 86 to 99.9% by weight, based on the molding composition P, of at least one graft copolymer composition AB, consisting of:
A: from 30 to 80% by weight, based on composition AB, of at least one thermoplastic copolymer A, produced from:
A1: from 50 to 95% by weight, based on the thermoplastic copolymer A, of a monomer A1 selected from styrene, α-methylstyrene, and mixtures of styrene with at least one other monomer selected from α-methylstyrene, p-methylstyrene, and C₁-C₈-alkyl (meth)acrylate; and
A2: from 5 to 50% by weight, based on the thermoplastic copolymer A, of a monomer A2 selected from acrylonitrile and mixtures of acrylonitrile with at least one other monomer selected from methacrylonitrile, acrylamide, vinyl methyl ether, anhydrides of unsaturated carboxylic acids, and imides of unsaturated carboxylic acids;
B: from 20 to 70% by weight, based on composition AB, of at least one graft copolymer B comprising:
B1: from 50 to 90% by weight, based on the graft copolymer B, of at least one graft base B1, which is obtained via emulsion polymerization of:
B11: from 70 to 99.9% by weight, based on the graft base B1, of at least one C₁-C₈-alkyl (meth)acrylate, as monomer B11;
B12: from 0.1 to 10% by weight, based on the graft base B1, of at least one polyfunctional crosslinking monomer B12; and
B13: from 0 to 29.5% by weight, based on the graft base B1, of at least one other copolymerizable monomer B13,
wherein the entirety of B11+B12+B13 provides 100% by weight of the at least one graft base B1; and
B2: from 10 to 50% by weight, based on the graft copolymer B, of at least one graft shell B2 which is obtained via emulsion polymerization, in the presence of the at least one graft base B1, of:
B21: from 50 to 100% by weight, based on the graft shell B2, of a monomer B21, selected from styrene, α-methylstyrene, and mixtures of styrene with at least one other monomer selected from α-methylstyrene, p-methylstyrene, and C₁-C₄-alkyl (meth)acrylate;
B22: from 0 to 50% by weight, based on the graft shell B2, of a monomer B22 selected from acrylonitrile and mixtures of acrylonitrile with at least one other monomer selected from methacrylonitrile, acrylamide, vinyl methyl ether, anhydrides of unsaturated carboxylic acids, and imides of unsaturated carboxylic acids; and
B23: from 0 to 20% of at least one further copolymerizable monomer B23,
wherein the entirety of B21+B22+B23 provides 100% by weight of the at least one graft shell B2;
wherein the entirety of graft base B1 and graft shell B2 provides 100% by weight of the at least one graft copolymer B;
C: 0.1 to 4% by weight, based on the thermoplastic molding composition P, of at least one UV absorber as component C; and
D: 0 to 10% by weight, based on the thermoplastic molding composition P, of at least one further additive as component D;
wherein the components A to D amount to 100% by weight of the molding composition P;
wherein the UV absorber component C comprises at least one organic or inorganic component with a UV absorption wavelength range of ≤380 nm;
wherein the UV absorber component C is at least partially selected from at least one white pigment and/or at least one dye with a UV absorption wavelength range of ≤380 nm;
wherein the thermoplastic molding composition P comprises≤0.2% by weight, based on the thermoplastic molding composition P, of a compound comprising a benzotriazole moiety represented by the following formula (I) and mixtures thereof: 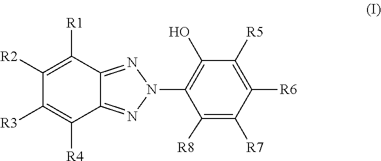
wherein R1, R2, R3, R4, R5, R6, R7, and R8 are independently selected from a hydrogen atom, a halogen atom, and an alkyl group having 1 to 5 carbon atoms.

2. The thermoplastic molding composition P of claim 1, wherein the graft copolymer component B has a weight-average particle diameter dw of at least 50 nm.

3. The thermoplastic molding composition P of claim 1, wherein the UV absorber component C comprises at least one dye with a UV absorption wavelength range from 250 nm to 380 nm and at least one white pigment, at least one black pigment, or at least one white pigment and at least one black pigment.

4. The thermoplastic molding composition P of claim 1, wherein the UV absorber component C comprises at least one dye with a UV absorption wavelength range of ≤380 nm and carbon black.

5. The thermoplastic molding composition P of claim 1, wherein the UV absorber component C comprises at least one dye with a UV absorption wavelength range of ≤380 nm, and wherein the at least one dye is selected from red, orange, and yellow dyes.

6. The thermoplastic molding composition P of claim 1, wherein the thermoplastic molding composition P comprises at least one hindered amine light stabilizer as additive component D.

7. The thermoplastic molding composition P of claim 6, wherein the component D comprises at least one hindered amine light stabilizer selected from compounds having the following formula (II): 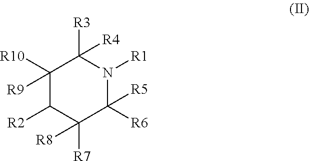
wherein
R1 represents a hydrogen atom or an alkyl group having 1 to 3 carbon atoms;
R2 represents a hydrocarbon group having 5 to 30 carbon atoms; and
R3, R4, R5, R6, R7, R8, R9, and R10 independently represent a hydrogen atom or an alkyl group having 1 to 5 carbon atoms.

8. The thermoplastic molding composition P according to claim 6, wherein the component D comprises at least one hindered amine light stabilizer selected from compounds having the following formula (II-a): 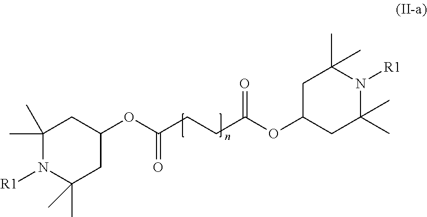
wherein
R1 represents independently from each other —H or —CH₃; and
n represents an integer from 1 to 8.

9. (canceled)

10. The thermoplastic molding composition P of claim 1, comprising less than 0.1% by weight, based on the thermoplastic molding composition P, of the UV absorber component C represented by formula (I).

11. The thermoplastic molding composition P of claim 1, wherein the thermoplastic molding composition P comprises from 0.01 to 1% by weight, based on the thermoplastic molding composition P, of at least one antioxidant as component D selected from sterically hindered phenolic antioxidants of the general formula (III) and mixtures thereof: 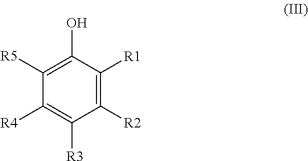
wherein
R1 to R5 independently represent a hydrogen atom or an alkyl group having 1 to 70 carbon atoms, wherein the hydrocarbon group optionally comprises at least one hetero atom selected from O and S, and wherein at least one of the substituents R1 and R5 represents a hydrocarbon group having at least 3 carbon atoms.

12. The thermoplastic molding composition P of claim 1, wherein the component D comprises at least one phosphorus- or sulfur-containing co-stabilizer.

13. The thermoplastic molding composition P of claim 1, wherein the at least one graft copolymer composition AB consists of:
A: 30 to 80% by weight, based on the graft copolymer composition AB, of at least one thermoplastic copolymer selected from poly(styrene-acrylonitrile) (SAN), poly(α-methyl styrene/acrylonitrile) (AMSAN), and mixtures thereof as component A; and
B: 20 to 70% by weight, based on the graft copolymer composition AB, of at least one graft copolymer B, comprising:
B1:50 to 90% by weight, based on the graft copolymer B, of at least one graft base B1, obtained by emulsion polymerization:
B11:70 to 99.9% by weight, based on the graft base B1, of n-butylacrylate, as monomer B11; and
B12:0.1 to 10% by weight, based on the graft base B1, of at least on poly-functional cross-linking monomer B12 selected from allyl(meth)acrylate, dihydrodicyclopentadienyl acrylate (DCPA), and a combination thereof;
wherein the sum of B11 and B12 equals 100% by weight of B1; and
B2:10 to 50% by weight, based on the graft copolymer B, of at least one graft shell B2, which is obtained via emulsion polymerization in the presence of at least one graft base B1:
B21 50 to 95% by weight, based on the graft shell B2, of a monomer B21 of styrene; and
B22 5 to 50% by weight, based on the graft shell B2, of at least one monomer B22 chosen from acrylonitrile or mixtures of acrylonitrile and at least one further monomer chosen from methacrylonitrile;
wherein the total sum of graft base B1 and graft shell B2 equals 100% by weight of the graft copolymer B, and
wherein the at least one graft copolymer B has a weight-average particle diameter dw of 50 to 1000 nm.

14. A method comprising producing a molded article using the thermoplastic molding composition P of claim 1.

15. A molded article comprising the thermoplastic molding composition P of claim 1.

16. The thermoplastic molding composition P of claim 1, wherein B13 is from 0% to 20% by weight.

17. The thermoplastic molding composition P of claim 1, wherein B13 is from 0% to 10% by weight.

18. The thermoplastic molding composition P of claim 1, wherein the UV absorber component C comprises at least one dye with a UV absorption wavelength range from 100 nm to 380 nm.

19. The thermoplastic molding composition P of claim 1, wherein the UV absorber component C comprises at least one dye with a UV absorption wavelength range from 200 nm to 380 nm.

20. The thermoplastic molding composition P of claim 1, wherein the UV absorber component C comprises at least one dye with a UV absorption wavelength range from 250 nm to 380 nm.

21. The thermoplastic molding composition P of claim 7, wherein the hydrocarbon group of R2 comprises at least one heteroatom selected from N and O.
